(19) United States
(12) Patent Application Publication
(10) Pub. No.: US 2013/0155860 A1
(43) Pub. Date: Jun. 20, 2013

(54) PACKET TRANSMISSION DEVICE AND METHOD OF TRANSMITTING PACKET

(71) Applicants: Chang-ho CHOI, Daejeon (KR); YongWook RA, Daejeon (KR); Tae Kyu KANG, Daejeon (KR)

(72) Inventors: Chang-ho CHOI, Daejeon (KR); YongWook RA, Daejeon (KR); Tae Kyu KANG, Daejeon (KR)

(73) Assignee: Electronics and Telecommunications Research Institute, Daejeon (KR)

(21) Appl. No.: 13/619,891

(22) Filed: Sep. 14, 2012

(30) Foreign Application Priority Data
Dec. 19, 2011 (KR) 10-2011-0137380

(51) Int. Cl. H04L 12/24; H04L 12/56

(52) U.S. Cl. 370/235; 370/400

(57) ABSTRACT

The inventive concept relates to a method of managing a packet being transmitted through a packet transmission network. The method may include distinguishing a buffer unit corresponding to the received data packet among a plurality of buffer units according to a type of a data packet received from the outside; comparing the number of packets stored in the distinguished buffer unit with a critical value; storing the received data packet in the distinguished buffer unit or a sub buffer unit corresponding to the distinguished buffer unit according to the comparing result; and transmitting the data packet stored in the distinguished buffer unit through a working path of the backbone network and transmitting the data packet stored in the sub buffer unit through a protection path of the backbone network.

### CROSS-REFERENCE TO RELATED APPLICATIONS

This U.S. non-provisional patent application claims priority under 35 U.S.C. §119 of Korean Patent Application No. 10-2011-0137380, filed on Dec. 19, 2011, the entire contents of which are hereby incorporated by reference.

### BACKGROUND

The present inventive concept herein relates to methods of managing packets being transmitted through a packet transmission network.

A requirement for packet service based on an internet protocol is increasing because of an increase of wireless internet users, the spread of internet protocol TV and diversification of personal multimedia device.

As a requirement for packet service based on IP increases due to an increase of wireless internet users, the spread of IPTV and diversification of personal multimedia platform, a technology is evolving from a transmission method based on a line using a TDM technology to a transmission method based on a packet.

To entrench a packet transmission technology including a conventional TDM (time division multiplexer) technology, the path management ability and a protection switching function of SDH (synchronous digital hierarchy) level are required. A PBB-TE (provider backbone bridge-traffic engineering) technology is given on the basis of statically setting a point to point tunneling path or a point to multipoint tunneling path by transferring a spanning tree function and a MAC address learning function among conventional ethernet functions to a management plane or a control plane. A MPLS-TP is based on MPLS technology but it is based on the premise that the MPLS-TP operates without ECMP (equal cost multiple path), a PHP (penultimate hop popping) and an IP forwarding function provided from a conventional MPLS and the MPLS-TP uses the same packet forwarding method as the MPLS and adds an OAM (operation and management) and a protection switching function that are needed for a packet transmission. As a protection switching method of MPLS-TP, a 1:1 linear protection switching method, a ring protection switching method and a sharing mesh protection switching method are in the process of standardization.

The PBB-TE and MPLS-TP technologies providing a packet transmission technology set an end-to-end working path and a protection path and provide a protection switching function through a periodic management, but by these results, there is a problem that an efficiency of link use is reduced by setting an extra protection path.

The packet transmission technology has been suggested to supplement problems of a conventional IP router and a present network constituted by an individual transmission network but has a task to solve the problems of a limit and an extendability of an inherent QoS management of packet network. The TCP/IP protocol currently being used causes considerable performance degradation under an environment that a packet loss is generated and needs a method that can flexibly cope with burst traffic when the burst traffic having a large capacity flows in because of optimization incompletion of end-to-end path.

A technology for guaranteeing QoS in a packet network has been actively studied. An IntSery technology and a DiffSery technology that are standardized in an internet engineering task force (IETF) which is an internet standard organization are well-known technologies for guaranteeing QoS. The IntSery technology can guarantee point-to-point QoS across the service. However, since the IntSery technology should reserve resources at every path of all the routers and should manage router states of all the paths, it is evaluated to be useless technology. The DiffSery technology is easily embodied and is suitable for a massive network. However, because of a limit of QoS management based on a class, the DiffSery technology cannot guarantee QoS when a band collision occurs on a service set to be the same class.

A flow based QoS management technology has been suggested as a QoS guarantee method of packet network. The suggested flow based QoS management technology provides a detailed QoS by classifying the inputted packets into flows having the same characteristic and by performing a queue management on each flow. However, as a traffic of a user increases and the number of flows that should be managed in a single node increases, a limitation occurs on a queue management by flow.

Another technology suggested as a QoS guarantee method in a packet network is a load dispersion technology using a multipath. However, an algorism selecting an optimum path among the multipath is complicated to be realized and cannot rapidly perform a switching operation when a problem occurs on a real path.

### SUMMARY

Embodiments of the inventive concept provide a packet transmission method. The packet transmission method may include distinguishing a buffer unit corresponding to the received data packet among a plurality of buffer units according to a type of a data packet received from the outside; comparing the number of packets stored in the distinguished buffer unit with a critical value; storing the received data packet in the distinguished buffer unit or a sub buffer unit corresponding to the distinguished buffer unit according to the comparing result; and transmitting the data packet stored in the distinguished buffer unit through a working path of the backbone network and transmitting the data packet stored in the sub buffer unit through a protection path of the backbone network.

Embodiments of the inventive concept also provide a packet transmission device. The packet transmission device may include a queuing block including a plurality of buffer units storing a plurality of data packets and a plurality of sub buffer units corresponding to the plurality of buffer units; a scheduling block transmitting data packets stored in the buffer units through a working path of backbone network and transmitting data packets stored in the sub buffer units through a protection path of backbone network; a classification block configured to distinguish buffer units corresponding to the received data packet among the buffer units according to a type of data packet received from the outside; and a load balancing block configured to store the received data packet in the sub buffer unit corresponding to the distinguished buffer unit when the number of data packets stored in the distinguished buffer unit is greater than a critical value.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 is a drawing illustrating a packet transmission network.

FIG. 2 is a block diagram illustrating a packet transmission device included in one of a plurality of backbone network edge nodes of FIG. 1.

FIG. 3 is a drawing illustrating first buffer units and second buffer units included in a buffer of FIG. 2.

FIG. 4 is a drawing illustrating a plurality of working path queues and protection path queues stored in a buffer.

FIG. 5 is a flow chart illustrating a packet transmission method of the packet transmission device of FIG. 2.

FIGS. 6 and 7 are drawings for explain a method of dispersing packets.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

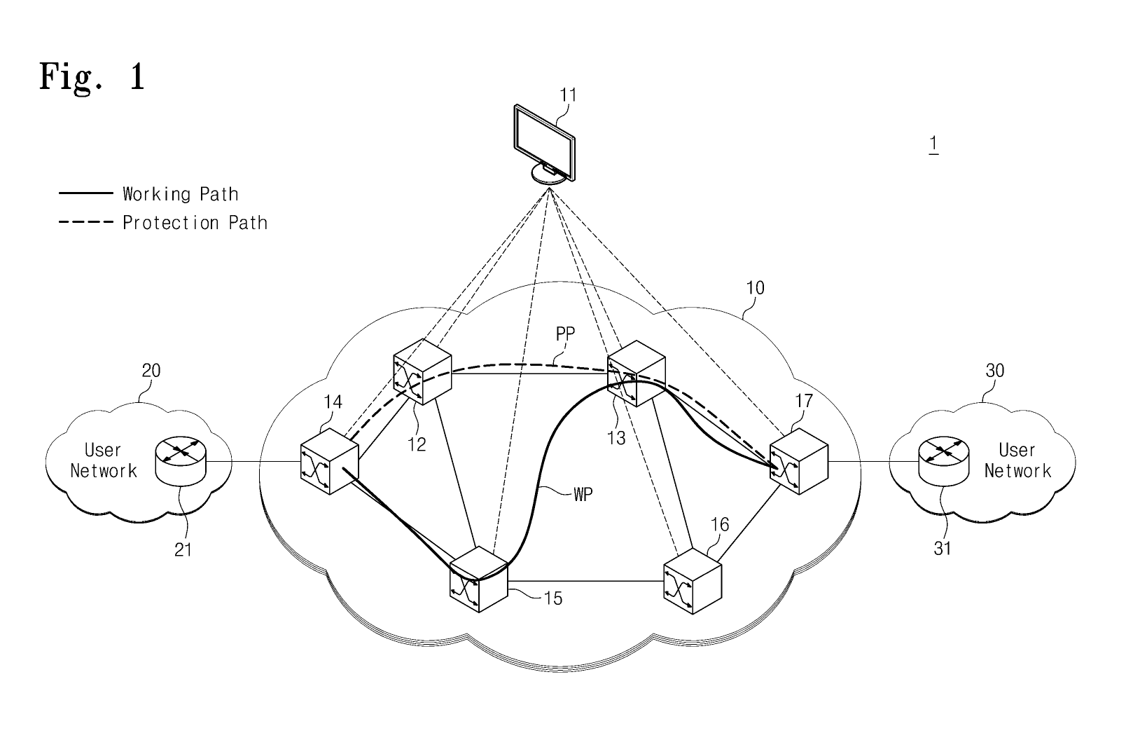

FIG. 1 is a drawing illustrating a packet transmission network 1. Referring to FIG. 1, the packet transmission network 1 includes a plurality of user networks 20 and 30 and a backbone network 10 connecting the user networks 20 and 30. The plurality of user networks 20 and 30 include user edge nodes 21 and 31. The backbone network 10 includes a plurality of transmission nodes 12, 13, 15 and 16 and a plurality of backbone network edge nodes 14 and 17.

The plurality of user networks 20 and 30 is connected to the backbone network 10 through the user edge nodes 21 and 31 respectively. The user edge nodes 21 and 31 are connected to the backbone network edge nodes 14 and 17 respectively. The backbone network edge nodes 14 and 17 provide a packet transmission service via the backbone network transmission nodes 12, 13, 15 and 16.

A packet transmitted through the backbone network 10 may include a data packet or an OAM packet monitoring a link state. A coloring process may be performed on the data packet according to the previously set QoS profile. On the basis of the OAM packet, a function of monitoring a link state periodically may be performed. If an obstacle of link is detected, an automatic protection switching function that the working path 14, 15, 13 and 17 is switched to the protection path 14, 12 13 and 17 is performed. If an obstacle of link is not detected, a path switching function is not performed and the working path is maintained. The working path may be a packet transport layer (PTL) tunnel. The protection path may be a protection PTL tunnel.

According to some embodiments of the inventive concept, in the case that the working path is expected to be overloaded, the protection path may be used to disperse a load of the working path.

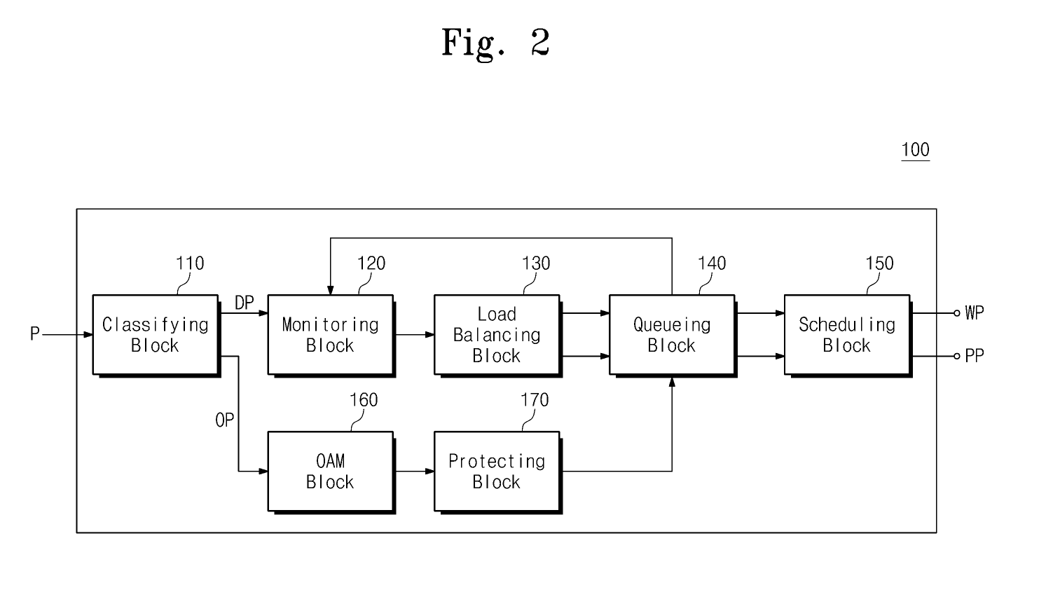

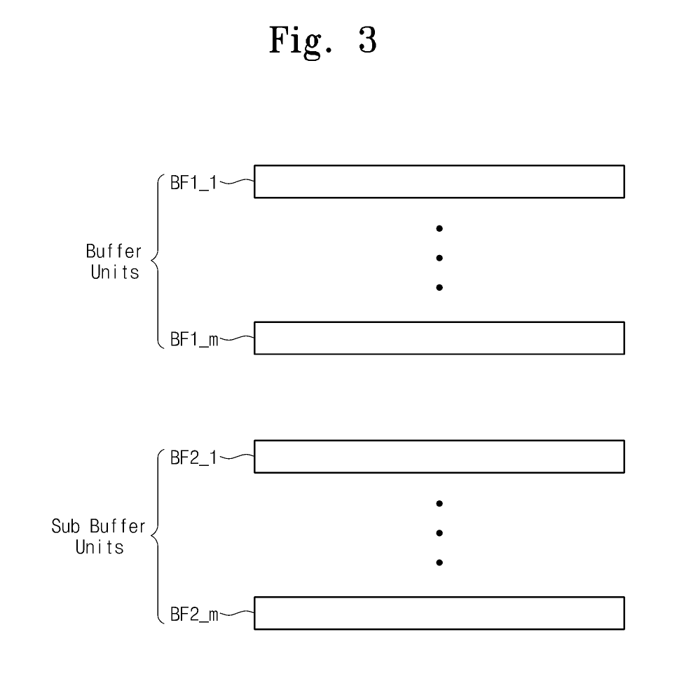

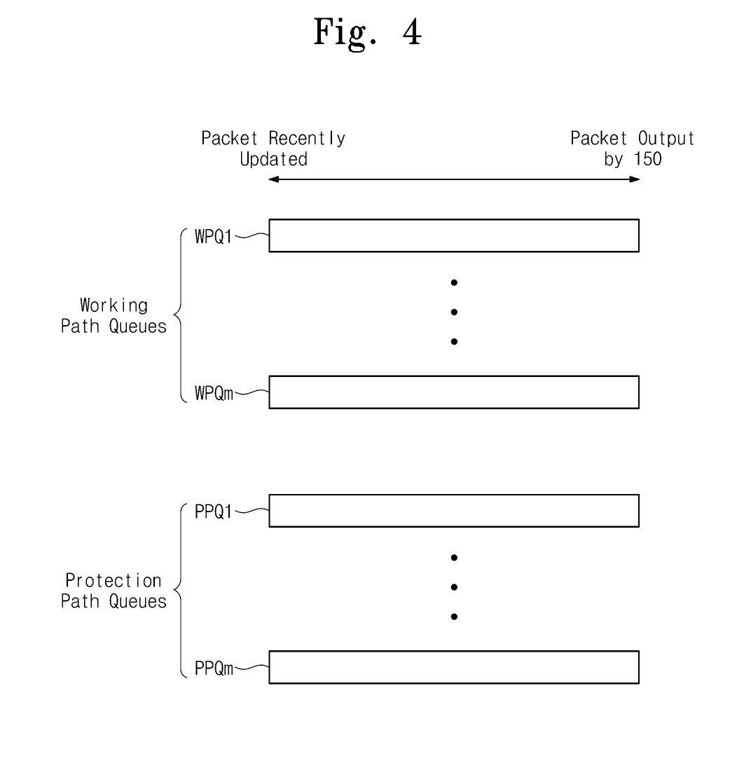

FIG. 2 is a block diagram illustrating a packet transmission device 100 included in one 14 of a plurality of backbone network edge nodes 14 and 17 of FIG. 1. FIG. 3 is a drawing illustrating buffer units BF1_1˜BF1_m and sub buffer units BF2_1˜BF2_m included in a queuing block 140 of FIG. 2. FIG. 4 is a drawing illustrating a plurality of working path queues WPQ1˜WPQm and protection path queues PPQ1˜PPQm stored in a queuing block 140 of FIG. 2.

Referring to FIG. 2, the packet transmission device 100 includes a classification block 110, a monitoring block 120, a load balancing block 130, a queuing block 140, a scheduling block 150, an OAM block 160 and a protection block 170.

The classification block 110 receives a packet P from a user edge node (e.g., 21 of FIG. 1). The classification block 110 classifies the received packet into a data packet DP and an OAM packet OP. The OAM packet OP means a packet for checking and monitoring a path state.

The classification block 110 distinguishes a buffer unit corresponding to the data packet DP among buffer units in the queuing block 140 according to a type of the data packet DP. For instance, the classification block 110 distinguishes a buffer unit in which the data packet DP is stored according to a destination node (e.g., 31 of FIG. 1) of the data packet DP. At this time, data packets stored in different buffer units are transmitted to different destination nodes respectively.

For instance, at least one of buffer units classified according to the destination node may be linked to some other buffer blocks. The classification block 110 distinguishes a buffer unit corresponding to the data packet DP according to the destination node of the data packet DP and may distinguish a buffer block to be stored in the data packet DP among some other buffer blocks linked to the buffer unit distinguished according to a service characteristic corresponding to the data packet DP. The data block corresponding to the data packet DP is distinguished according to various service characteristics such as the type of service, a service bandwidth, a security level of service, etc. being provided to a user transmitting the data packet DP.

Referring to FIG. 3, the queuing block 140 includes the buffer units BF1_1˜BF1_m and the sub buffer units BF2_1˜BF2_m. Packets stored in the buffer units BF1_1˜BF1_m are transmitted to the destination node through the working path by the scheduling block 150. Packets stored in the sub buffer units BF2_1˜BF2_m are transmitted to a destination node through the protection path by the scheduling block 150. If one protection path is assigned to one working path, the buffer units BF1_1˜BF1_m correspond to the sub buffer units BF2_1˜BF2_m respectively. That is, as illustrated in FIG. 3, the equal number of sub buffer units BF2_1˜BF2_m to the buffer units BF1_1˜BF1_m is provided. However, the inventive concept is not limited thereto. If one protection path is assigned to a plurality of working paths, the number of sub buffer units is one. The number of sub buffer units corresponding to the buffer units BF1_1˜BF1_m may be changed in a variety of ways. For instance, the queuing block 140 may be storage medium (e.g., a volatile storage medium or a nonvolatile storage medium). The buffer units BF1_1˜BF1_m and the sub buffer units BF2_1˜BF2_m are arbitrary storage areas in the queuing block 140. Each of the buffer units BF1_1˜BF1_m and each of the sub buffer units BF2_1˜BF2_m are provided to be an independent constituent element.

Referring to FIG. 4, the buffer units BF1_1˜BF1_m may includes a plurality of working path queues (WPQ1˜WPQm). The sub buffer units BF2_1˜BF2_m may include a plurality of protection path queues (PPQ1˜PPQm). The plurality of protection path queues (PPQ1˜PPQm) correspond to the plurality of working path queues (WPQ1˜WPQm) respectively. Each queue inputs and outputs packets according to a first in first out (FIFO) method. The packet recently updated among packets stored in each queue is output last. The earliest updated packet among packets stored in each queue is output first. It is assumed that the plurality of working path queues (WPQ1˜WPQm) and the plurality of protection path queues (PPQ1˜PPQm) are stored in the queuing block 140.

Referring back to FIG. 2, the classification block 110 distinguishes a working path queue corresponding to the data packet DP. The monitoring block 120 compares the number of packets stored in the distinguished working path queue with a critical value and controls the load balancing block 130. According to a control of the monitoring block 120, the load balancing block 130 stores the data packet PD in the distinguished working path queue or the protection path queue corresponding to the working path queue.

When the number of packets stored in the distinguished working path queue is greater than the critical value, the monitoring block 120 controls the load balancing block 130 to store the data packet DP in the protection path queue corresponding to the distinguished working path queue. When the number of packets stored in the distinguished working path queue is equal to or smaller than the critical value, the monitoring block 120 controls the load balancing block 130 to store the data packet DP in the distinguished working path queue.

The monitoring block 120 and the load balancing block 130 additionally perform a function of maintaining packets that belong to the same session at the same path. The same session means gathering of packets that are generated by the same user in a user network (e.g., 20 of FIG. 1) and are transmitted to the same user in another user network (e.g., 30 of FIG. 1). Packets included in the same session may include the same source IP information and the same destination IP information. Thus, a sequence mismatch problem due to load dispersion of packets that belong to the same session may be solved.

When a specific working path queue exceeds the critical value and thereby a load dispersion function is performed, to select extra paths, a method of selecting the previously designated protection path may be used without using a conventional method of selecting the optimum path among multi paths. Packets stored in the protection path queue are transmitted to the destination through the predetermined protection path. Thus, an additional delay time of when calculating the protection path is not generated.

The load balancing block 130 may increase a load dispersion weight by stages when determining the load dispersion weight of the working path and the protection path. When receiving an excess message of an initial critical value, the monitoring block 120 maintains a ratio of data packets stored in the working path to data packets stored in the protection path at 90:10. In case of continuously receiving an excess message of critical value, the monitoring block 120 controls a ratio of data packets stored in the working path to data packets stored in the protection path in order of 80:20 and 70:30.

The scheduling block 150 transmits packets stored in the working path queues WPQ1˜WPQm to the destination node through the working path. The scheduling block 150 transmits packets stored in the protection path queues PPQ1˜PPQm to the destination node through the protection path. The scheduling block 150 transmits packets stored in the working path queues WPQ1˜WPQm and the protection path queues PPQ1˜PPQm to the destination node according to the previously set method.

The OAM block 160 receives OAM packet (OP). The OAM block 160 monitors link states of all the paths on the basis of the OAM packet. The OAM block 160 can periodically receive the OAM packet and can periodically monitor link states of all the paths. If it is detected for the working path to be abnormal, the OAM block 160 provides the detected working path information to the protection block 170. On the basis of the detected working path information, the protection block 170 controls the queuing block 140 to store data packet DP in the protection path queue corresponding to the working path queue instead of the working path queue regardless of the number of packets of the working path queue. If an abnormal working path is detected, data packets received thereafter are transmitted through the protection path queue.

When there is an obstacle of link in the working path, the load balancing block 130 preferentially substitutes the working path by the protection path in line with the OAM block 160 and the protection block 170. When there is not an obstacle of link in the working path, the load balancing block 130 performs a load dispersion function on packets stored in the queuing block 140.

According to some embodiments of the inventive concept, in the case that as traffic is concentrated on the backbone edge node (14 or 17) of the packet transmission network (1 of FIG. 1), an overload occurs, the working path and the protection path may be used. Thus, a bandwidth of the packet transmission network 1 may be effectively used.

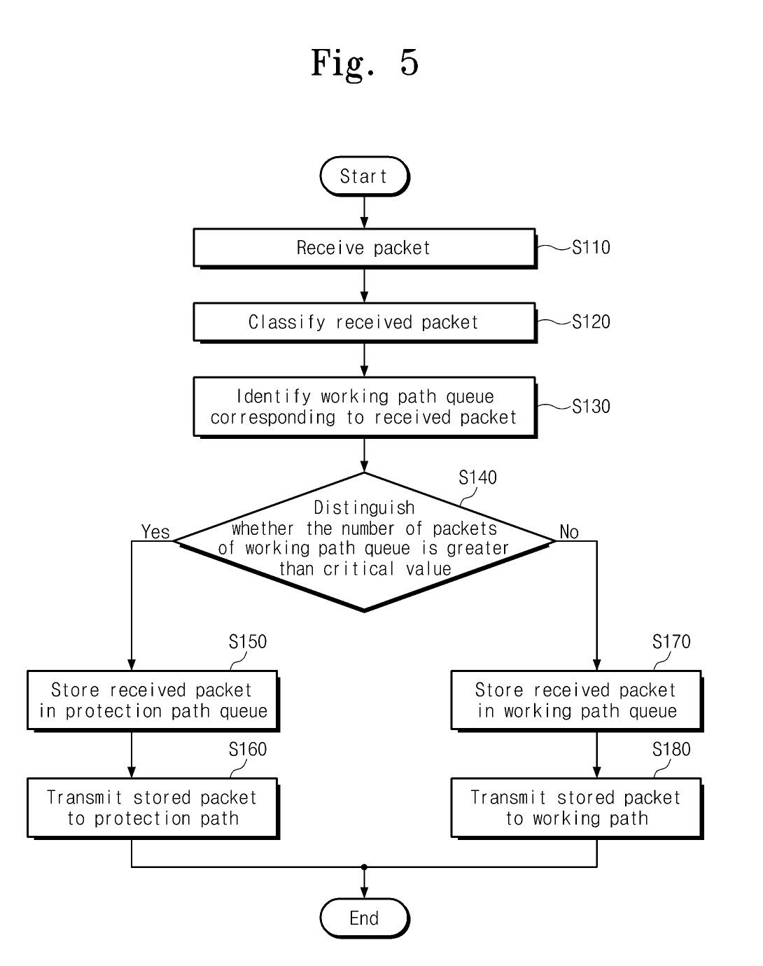

FIG. 5 is a flow chart illustrating a packet transmission method of the packet transmission device 100 of FIG. 2. Referring to FIGS. 1, 2 and 5, in S110, the packet transmission device 100 receives a packet. In S112, the classification block 110 distinguishes whether the received packet is the data packet DP or the OAM packet. In S130, if the received packet is the data packet DP, the classification block 110 identifies the working path queue in which the data packet DP will be stored according to the destination and service characteristic of the data packet DP.

In S140, the monitoring block 120 distinguishes whether the number of packets stored in the identified working path queue (e.g., WPQ1 of FIG. 4) is greater than the critical value or not. If so, S150 is performed. If not so, S170 is performed.

In S150, the received packet is stored in the protection path queue (e.g., PPQ1 of FIG. 4) corresponding to the working path queue. In S160, the packet stored in the protection path queue is transmitted through the protection path by the scheduling block 150.

In the S170, the received packet is stored in the working path queue. In S180, the packet stored in the working path queue is transmitted through the working path by the scheduling block 150.

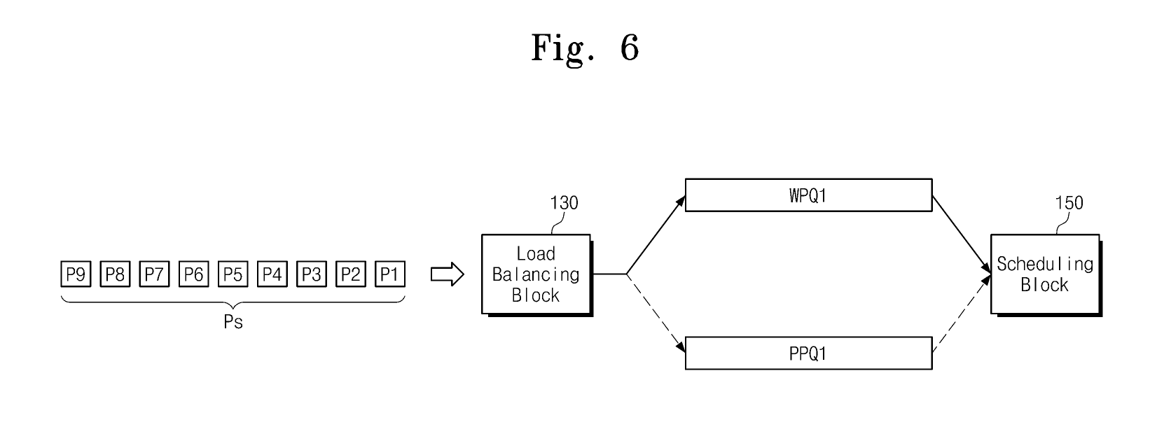

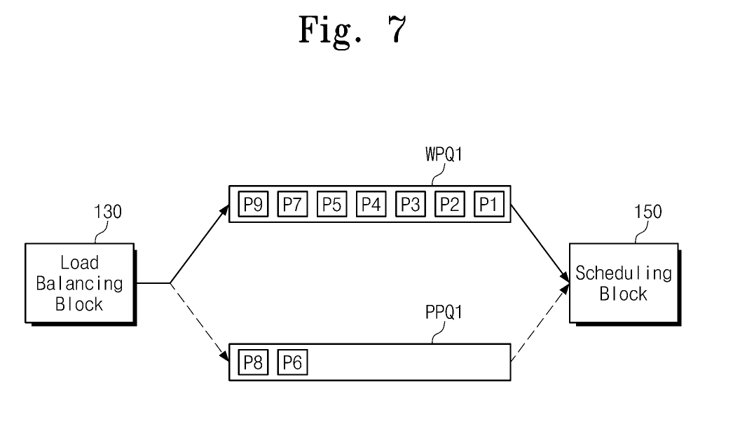

FIGS. 6 and 7 are drawings for explain a method of dispersing packets Ps.

In explanation with reference to FIGS. 6 and 7, for convenience of description, packets stored only in the first working path queue (WPQ1) and the first protection path queue (PPQ1) are described.

First, referring to FIG. 6, the load balancing block 130 stores packets Ps received to the packet transmission device 100 in the first working path queue WPQ1 and the first protection path queue PPQ1. The scheduling block 150 transmits packets stored in the working path queues WPQ1˜WPQm through the working path according to the predetermined method. The scheduling block 150 transmits packets stored in the protection path queues PPQ1˜PPQm through the protection path according to the predetermined method.

Assume that first through ninth packets P1˜P9 are sequentially received. Assume that when the first through fifth packets P1˜P5, the seventh packet P7 and the ninth packet P9 are received, the number of packets stored in the first working path queue WPQ1 is equal to or smaller than the critical value. Assume that when the sixth and eighth packets P6 and P8 are received, the number of packets stored in the first working path queue WPQ1 is greater than the critical value.

Referring to FIG. 7, when the first through fifth packets P1˜P5 are received, since the number of packets stored in the first working path WPQ1 is equal to or smaller than the critical value, the first through fifth packets P1˜P5 are stored in the first working path queue WPQ1. When the sixth packet P6 is received, since the number of packets stored in the first working path queue WPQ1 is greater than the critical value, the sixth packet P6 is stored in the first protection path queue PPQ1. When the seventh packet P7 is received, since the number of packets stored in the first working path WPQ1 is equal to or smaller than the critical value, the seventh packet P7 is stored in the first working path queue WPQ1. When the eighth packet

P8 is received, since the number of packets stored in the first working path queue WPQ1 is smaller than the critical value, the eighth packet P8 is stored in the first protection path queue PPQ1. When the ninth packet P9 is received, since the number of packets stored in the first working path queue WPQ1 is equal to or smaller than the critical value, the ninth packet P9 is stored in the first working path queue WPQ1.

Since the first through ninth packets P1˜P9 are dispersed to be stored in the first working path queue WPQ1 and the first protection path queue PPQ1, a load of the working path is reduced.

According to some embodiments of the inventive concept, in the case that as traffic is concentrated on a specific node of the packet transmission network, an overload occurs, the previously set protection path for a switching function of the working path and the protection path may be used. Thus, a bandwidth of the packet transmission network can be effectively used and reliability of packet transmission may be improved.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the present invention. Accordingly, all such modifications are intended to be included within the scope of the present invention as defined in the claims. The present invention is defined by the following claims, with equivalents of the claims to be included therein

What is claimed is:

1. A method of transmitting a data packet through a backbone network comprising:
distinguishing a buffer unit corresponding to a received data packet among a plurality of buffer units according to a type of the data packet received from the outside;
comparing the number of packets stored in the distinguished buffer unit with a critical value;
storing the received data packet in the distinguished buffer unit or a sub buffer unit corresponding to the distinguished buffer unit according to the comparing result; and
transmitting the data packet stored in the distinguished buffer unit through a working path of the backbone network and transmitting the data packet stored in the sub buffer unit through a protection path of the backbone network.

2. The method of claim 1, wherein storing the received data packet comprises storing the received data packet in the sub buffer unit corresponding to the distinguished buffer unit when the number of data packets stored in the distinguished buffer unit is greater than the critical value and storing the received data packet in the distinguished buffer unit when the number of data packets stored in the distinguished buffer unit is equal to or smaller than the critical value.

3. The method of claim 1, wherein the data packets stored in the plurality of buffer units and the sub buffer units are input and output according to a First in First out method.

4. The method of claim 1, wherein a destination on the backbone network connected to the working path and the protection path respectively is the same.

5. The method of claim 1, wherein distinguishing a buffer unit corresponding to the received data packet comprises distinguishing a buffer unit corresponding to the received data packet according to at least one of a destination node of the received data packet among nodes of the backbone network and a service characteristic corresponding to the received data packet.

6. A packet transmission device comprising:
a queuing block including a plurality of buffer units storing a plurality of data packets and a plurality of sub buffer units corresponding to the plurality of buffer units;
a scheduling block transmitting data packets stored in the buffer units through a working path of backbone network and transmitting data packets stored in the sub buffer units through a protection path of backbone network;
a classification block configured to distinguish buffer units corresponding to the received data packet among the buffer units according to a type of data packet received from the outside; and
a load balancing block configured to store the received data packet in the sub buffer unit corresponding to the distinguished buffer unit when the number of data packets stored in the distinguished buffer unit is greater than a critical value.

7. The packet transmission device of claim 6, wherein the load balancing block is configured to store the received data packet in the distinguished buffer unit when the number of data packets stored in the distinguished buffer unit is equal to or smaller than the critical value.

8. The packet transmission device of claim 6, further comprising a monitoring block configured to compare the number of data packets stored in the distinguished buffer unit with the critical value.

9. The packet transmission device of claim 8, wherein the monitoring block is configured to generate an excess message of critical value when the number of data packets stored in the distinguished buffer unit is greater than the critical value and wherein the load balancing block is configured to store the received data packet in the sub buffer unit corresponding to the distinguished buffer unit when receiving the excess message of critical value and store the received data packet in the distinguished buffer unit when not receiving the excess message of critical value.

10. The packet transmission device of claim 6, wherein the plurality of buffer units and data packets stored in the sub buffer units are input and output according to a First in First out method.

11. The packet transmission device of claim 6, wherein the data packets are stored in the plurality of buffer units according to a type of each of the data packets.

12. The packet transmission device of claim 6, wherein the classification block is configured to distinguish a buffer unit corresponding to the received data packet according to at least one of a destination node of the received data packet among nodes of the backbone network and a service characteristic corresponding to the received data packet.
